(19) United States
(12) Patent Application Publication
(10) Pub. No.: US 2024/0365724 A1
(43) Pub. Date: Nov. 7, 2024

(54) Solar Harvesting Optimized Greenhouse

(71) Applicant: Oren Aharon, Haifa (IL)

(72) Inventor: Oren Aharon, Haifa (IL)

(21) Appl. No.: 18/144,204

(22) Filed: May 7, 2023

(51) Int. Cl. A01G 9/14; G02B 26/08

(52) U.S. Cl. CPC A01G 9/14; G02B 26/08

(57) ABSTRACT

An improved method and apparatus are presented for controlling the growth environment of a greenhouse. The preferred approach involves mounting a mirror on the rooftop of the greenhouse along its longest axis. The mirror is motorized and can be directed to reflect sunlight towards the plants in the growing area, or to redirect excessive radiation away from the plants and back into the environment. A motorized stage is attached to the mirror axis, which can be adjusted to change the direction of the mirror based on the greenhouse's illumination requirements. A computer software algorithm will continuously examine the reflected solar energy and the required temperature and then make necessary adjustments to the mirror. The goal of this innovation is to enable the construction of multi-level greenhouses that meet space limitations common in urban areas.

### BACKGROUND OF THE INVENTION

### 1. Field of Invention

For many decades, the greenhouse concept has been a pivotal technology in cultivating crops in challenging external climates while safeguarding the internal environment from undesirable external effects. The approach hinges on utilizing solar energy through diffusion from the transparent structure. However, a significant limitation of this technology is that it necessitates vast tracts of land, making it more suitable for rural settings located far from consumers in urban areas. The current invention aims to greatly enhance crop-growing methods and introduce a new paradigm of multi-level greenhouses. The primary strategy involves harnessing solar energy during hours that are presently unutilized in current technology, thus enabling cultivation in vertical, multi-level greenhouses.

### 2. Description of the Related Art

For many years, greenhouses have been utilized to create a controlled environment for cultivating plants, typically taking the form of a framed structure with a roof that allows some degree of sunlight penetration. Plants are placed inside the greenhouse and, in traditional constructions, are kept hydrated and maintained at a temperature above freezing. However, problems occur when solar energy is scarce in the morning and in the afternoon and night while at noon, the greenhouse can become quite hot with temperatures ranging well above 25 degrees Celsius. Furthermore, since most of the energy is delivered from the sun during mid-day, this prevents the building of a multi-level greenhouse which is better suitable for urban environment.

### SUMMARY

Given the limitations of traditional greenhouse setups, the primary aim of the present invention is to revamp the greenhouse growth process by enhancing environmental control through better utilization of solar energy during sunrise and sunset, while also mitigating harmful high energy levels by reflecting them away from the greenhouse interior to prevent excessive temperature increases. The disclosed technology incorporates an elongated mirror, ideally positioned on the rooftop of the greenhouse, capable of redirecting sunlight towards the growing areas, particularly when the sunlight is not naturally directed towards these areas. Additionally, in situations of excessive sun exposure, the mirror can reflect the excess solar radiation away to avoid potential harm to the crops.

Another objective of the present invention is to facilitate the construction of a multi-level greenhouse that can redirect sunlight from its sidewalls towards the growing area, particularly during morning and afternoon hours. In addition, the system is designed to direct sunlight towards solar panels mounted in close proximity to the greenhouse for charging electricity batteries.

Yet another object of the present invention is to provide air movement in the internal part of the greenhouse by moving the mirrors back and forth, mimicking the air movement that the growth requires for best performance.

To summarize, the patent deals with a greenhouse construction that enhances plant growth and daylight illumination, including a greenhouse structure featuring a transparent roof and frame that provides an interior space for plants to grow, an elongated bifacial mirror that runs the entire length of the greenhouse, attached to a rooftop-mounted shaft, a power drive with a motor capable of moving the mirror in response to processed inputs, detector mechanisms that measure the temperature within the greenhouse and the amount of sunlight that enters the space, and a micro-controller that processes the collected data and activates the motor accordingly. Furthermore, the technology could be applied to a multi-level greenhouse construction having two or more levels of greenhouse structures arranged vertically, with each level featuring an elongated bifacial mirror that spans the entire length of the greenhouse, power drive motors that regulate the angle of each mirror in relation to the position of the sun and the growth levels of the plants, and microcontrollers that collect and process data from each level and activate the motors accordingly.

### BRIEF DESCRIPTION OF THE DRAWINGS

FIG. 1 is a schematic illustration of the disclosed art showing the greenhouse design and the sun's trajectory relative to the greenhouse.

FIG. 2 is a schematic of the proposed system, showing the enabled multi-level greenhouse using the disclosed technology.

FIG. 3 is a simplified schematic of proposed greenhouse with a bifacial solar panel mounted on the roof, preferable on its apex, to enable mirrors to aim solar energy to said solar panel.

### DETAILED DESCRIPTION OF THE DRAWINGS

The used terminology for specific embodiments is used for better understanding and is not intended to limit the described art.

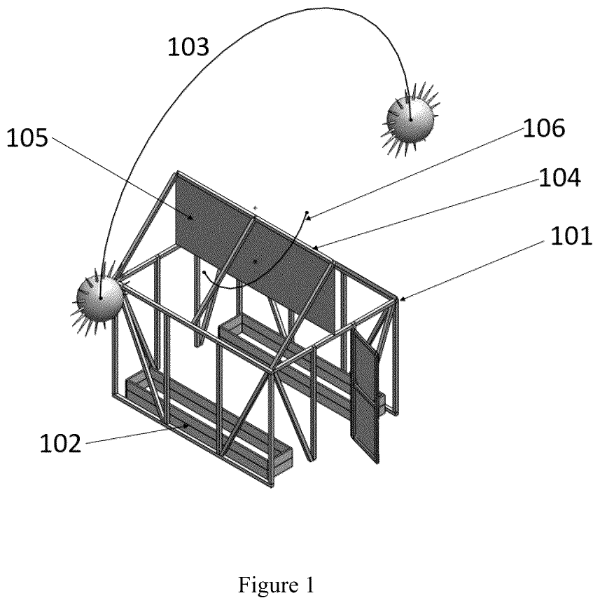

The present invention showcases a greenhouse design, depicted in FIG. 1. The greenhouse frame is constructed using contemporary technologies, including a frame labeled as 101, a growth area identified as 102, and a rooftop designated as 104 that houses a shaft and motor connected to a bifacial mirror 105. The motor powers the mirror to redirect sunlight to different areas within or outside the greenhouse, while the mirror direction is regulated by an external driver and microcontroller that dictate the appropriate mirror angles relative to the sun's trajectory 103. The movement arc of the mirror's edge is denoted as 106.

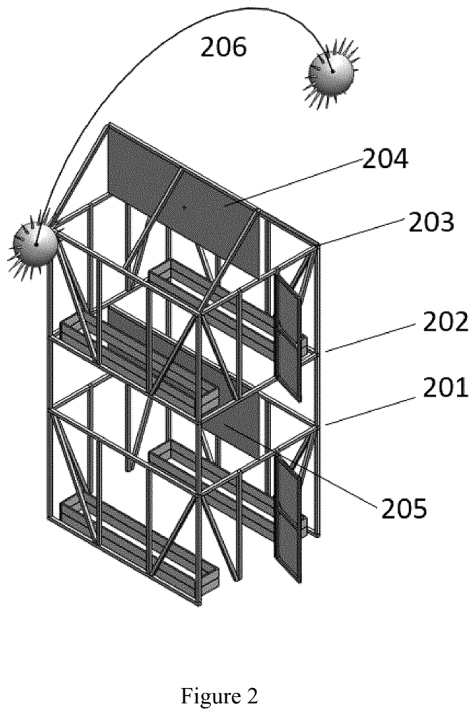

FIG. 2 illustrates how this technology can be implemented to direct sunlight towards the growth area during sunrise and sunset, which is crucial for optimal plant growth. This implementation is particularly well-suited for constructing multi-level greenhouses in urban areas. The frame for this greenhouse, denoted as 201, is similar to the one presented in FIG. 1. The growth area floor for the second level is labeled as 202, while 203 corresponds to the greenhouse frame for the second level. The elongated bifacial mirrors are identified as 204 and 205. The trajectory of the sun, represented as 206, moves from east to west above the greenhouse. As the sun enters the greenhouse from the east side through the transparent roof, mirror 204 redirects the sunlight towards the growth area. As the sun proceeds on its trajectory, the reflected sunlight can be directed outside the greenhouse through the roof, if necessary, to prevent excessive heat buildup. The same process is repeated for the west wing of the multi-level greenhouse as the sun moves towards the west.

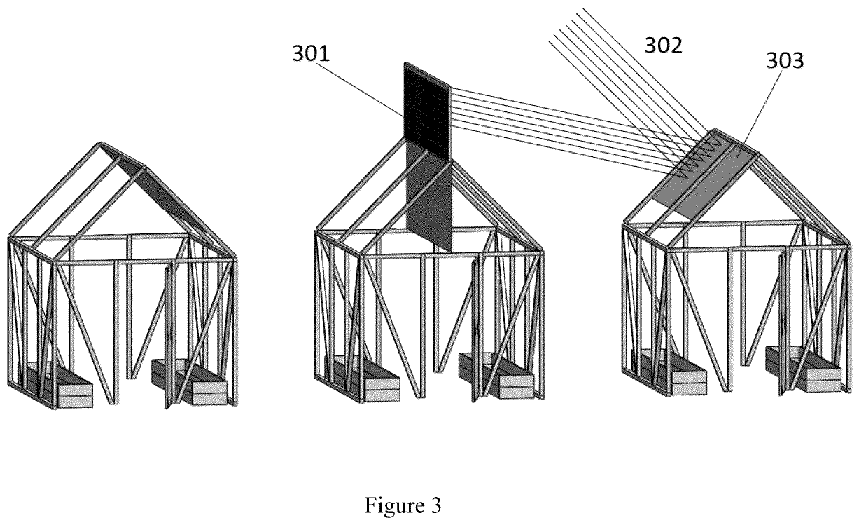

FIG. 3 illustrates yet another possible configuration where each greenhouse has a mounted bifacial solar panel on its rooftop, preferably on its apex. For demonstration purposes, only one panel is mounted in a simplified illustration. However, it should be clear that this arrangement is applicable to all greenhouses. In instances where a greenhouse receives excessive radiation the mirror will be moved to reflect the excessive radiation towards the solar panel, typically around noontime. The bifacial solar panel is aligned to face East in the morning and West in the afternoon, ensuring that the solar panel is illuminated for most of the day due to the mirrors orientation at noontime. In the diagram, 301 represents the mounted solar panel, 302 represents the incoming radiation, and 303 represents the mirror reflecting the excessive solar radiation towards the solar panel (301).

1. A greenhouse construction that enhances plant growth and daylight illumination, comprising:
a greenhouse structure featuring a transparent roof and frame that provides an interior space for plants to grow;
an elongated bifacial mirror that runs the entire length of the greenhouse, attached to a rooftop-mounted shaft;
a power drive with a motor capable of moving the mirror in response to processed inputs;
detector mechanisms that measure the temperature within the greenhouse and the amount of sunlight that enters the space; and
a micro-controller that processes the collected data and activates the motor accordingly.

2. A multi-level greenhouse construction according to claim 1, comprising of:
two or more levels of greenhouse structures arranged vertically, with each level featuring an elongated bifacial mirror that spans the entire length of the greenhouse;
power drive motors that regulate the angle of each mirror in relation to the position of the sun and the growth levels of the plants; and
microcontrollers that collect and process data from each level and activate the motors accordingly.

3. A greenhouse construction according to claim 1, comprising of:
a bifacial solar panel mounted vertically on its apex rooftop, facing East/West direction; and
a mirror according to claim 1 capable to direct solar radiation to solar panels.
